(19) United States
(12) Patent Application Publication
(10) Pub. No.: US 2007/0083846 A1
(43) Pub. Date: Apr. 12, 2007

(54) Optimized modules' proximity correction

(75) Inventors: Harry Chuang, Austin, TX (US); Cheng-Cheng Kuo, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/192,254

(22) Filed: Jul. 28, 2005

(51) Int. Cl. G06F 17/50

(52) U.S. Cl. 716/19

(57) ABSTRACT

A method comprising dissecting a photomask pattern layout into a plurality of segments, each segment having at least one evaluation point, applying a rule-based MPC to the photomask pattern layout and generating a rule-based MPC result, and applying a model-based MPC to the plurality of segments of the photomask pattern layout and generating an MPC correction that is influenced by the rule-based MPC result.

### BACKGROUND

Since the invention of the integrated circuit (IC), semiconductor chip features have become exponentially smaller and the number of transistors per device exponentially larger. Advanced ICs with sub-micron feature sizes are becoming conventional. Improvements in overlay tolerances in photolithography and the introduction of new radiation sources with progressively shorter wavelengths have enabled significant reduction in the resolution limit far below one micron.

Sub-wavelength lithography, however, places large demands on lithographic and etching processes, such as reactive ion etching (RIE). Pattern fidelity can deteriorate dramatically in sub-wavelength lithography and etching. The resulting semiconductor features may deviate significantly in geometry from the original pattern. These distortions include line-width variations dependent on pattern density, which affect a device's speed of operation, and line-end shortening and corner rounding, which can break connections to contacts. The problem in the lithography process is commonly referred to as an optical proximity effect. Combined with the loading effect in RIE and other modules, the more general problem is called modules' proximity effect.

Numerous techniques generally termed modules' proximity correction (MPC) have been developed to address this phenomenon. The two main classification of MPC are rule-based and model-based MPC. Each method involves subdividing polygons into smaller shapes or edge segments, moving or adding to the shapes, performing a fast simulation to determine if the new locations are better, moving them somewhere else, and iteratively repeating this process. In rule-based MPC, transformations from design or “target” shape to mask shape are specified in terms of a set of transformation rules. In model-based MPC, the mask-to-wafer shape transformations are represented by a mathematical model and the design-shape-to-mask transformation is performed by incremental solving the inverse problem of what mask geometry would yield a pattern equivalent to the desired design pattern.

### BRIEF DESCRIPTION OF THE DRAWINGS

Aspects of the present disclosure are best understood from the following detailed description when read with the accompanying figures. It is emphasized that various features are not necessarily drawn to scale. In fact, the dimensions of the various features may be arbitrarily increased or reduced for clarity of discussion.

FIG. 1 is a simplified flow diagram of an embodiment of optimized modules' proximity correction;

FIG. 2 is a partial plan view of a mask geometry showing exemplary dissected segments and evaluation points; and

FIG. 3 is a simplified flowchart of an embodiment of optimized optical proximity correction.

### DETAILED DESCRIPTION

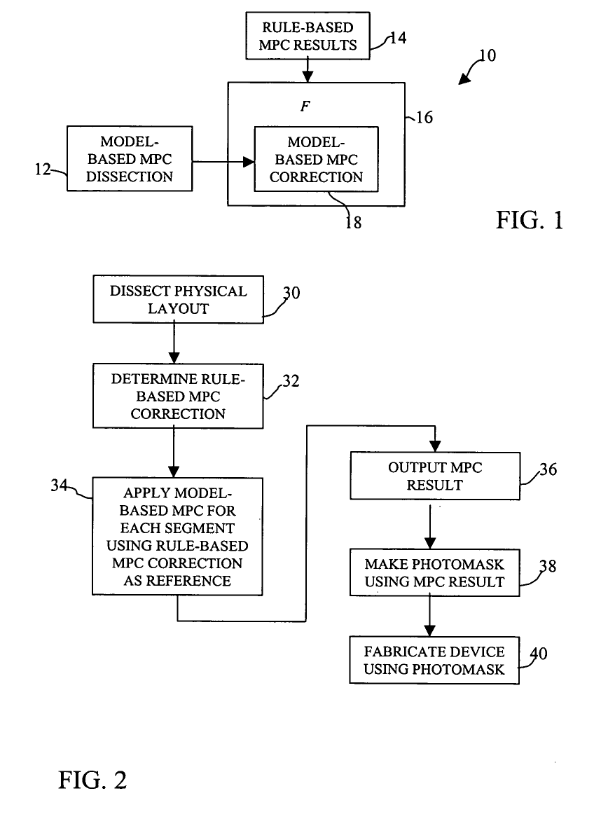

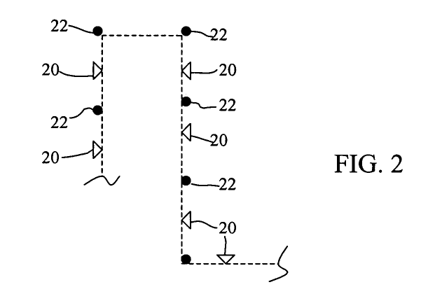

FIG. 1 is a simplified flow diagram of an embodiment of optimized modules' proximity correction (MPC) 10. MPC 10 employs a proximity effect model-based MPC technique that is preferably tailored to the fabrication process and equipment in question. In optimized MPC 10, a dissection 12 according to the model-based MPC method is first performed. The dissection step generally studies the mask pattern geometries and dissects or divides the pattern geometry into a plurality of segments, where the dissection points 20 are denoted by triangles in FIG. 2. In particular, the edges, corners, and line-ends of the pattern may be dissected according to a predetermined technique or method. The definition of these MPC segments may include their respective location in the layout, as well as their shape and size. In each generated segment, one or more evaluation points 22 may be determined or identified. The evaluation points of each segment may be equidistantly located in a segment or they may be more concentrated in areas that required more precise correction. If only one evaluation point is defined for each segment, the evaluation point may be located at a mid-point of the segment between two adjacent dissection points, for example. Those of ordinary skill in the art can appreciate that the partial physical layout of FIG. 2 is a rudimentary example, and more generally embodiments of the present disclosure may be applied to polysilicon gates, other polysilicon features, and other types of non-polysilicon device features, and which may be isolated, semi-isolated, semi-dense, and/or dense.

A rule-based MPC 14 is then performed on the mask pattern with its output provided to a function, F, denoted by reference numeral 16. Function 16 is then used to apply the results of rule-based MPC 14 to one or more evaluation points 22 of the dissected segments of the mask pattern so as to optimally influence the model-based MPC correction step 18. Rule-based MPC is often imprecise and time consuming to revise and test. Model-based MPC often results in a mask layout that has more precision with fewer off-line fabrication trial runs.

Referring to FIG. 3 for a flowchart of an embodiment of optimized modules' proximity correction. A physical dissection of the pattern layout is performed in step 30. Segments and one or more evaluation points within each segment are determined in this step. In step 32, a rule-based MPC technique is applied to the pattern layout, which may or may not take into account of the segments and the evaluation points within the segments. The rule-based MPC may provide a modified pattern layout that changes the pattern geometries according to a set of predetermined rules. In step 34, model-based MPC is applied to each segment. The final correction in model-based MPC takes into account the pattern modifications suggested by the rule-based MPC. Model-based MPC correction may be accomplished according to simulation results of an empirical model. This is characterized by empirical semiconductor wafer data and test patterns. Function 16 (FIG. 1) causes rule-based MPC results to be used as a reference in the model-based MPC correction. In other words, function 16 causes the rule-based MPC results to influence the model-based MPC. For example, the rule-based MPC results may cause the method-based MPC to apply a deviation or bias of a pattern edge in a certain direction and/or by a certain amount. The result from model-based MPC is an optimized model-based MPC outcome that has corrected geometries that do not exhibit the typical sharp or angular jigs and jags of rule-based MPC. The resultant corrected geometries have a smoother outline and more gradual changes. The final optimized MPC result is then provided as an output in step 36. In subsequent steps 38 and 40, a photomask is prepared according to the optimized MPC method, and a semiconductor device is fabricated using the photomask in photolithography and the resultant patterned layer is then used for etching, deposition, diffusion, or some other material altering process.

It should be noted that the resultant optimized MPC pattern may modify the line lengths, thicknesses, and corners, adding assist features such as scattering bars (SB's) and anti-scattering bars (ASB's). Other types of MPC modifications may also be implemented. However, the optimized MPC method results in more gradual changes unlike the sharp and drastic changes commonly seen in rule-based and model-based MPC methods when they are applied independently.

What is claimed is:

1. A method comprising:
dissecting a photomask pattern layout into a plurality of segments, each segment having at least one evaluation point;
applying a rule-based MPC to the photomask pattern layout and generating a rule-based MPC result; and
applying a model-based MPC to the plurality of segments of the photomask pattern layout and generating an MPC correction that is influenced by the rule-based MPC result.

2. The method of claim 1, wherein applying a model-based MPC comprises deviating an outline of the photomask pattern layout in a predetermined direction in response to the rule-based MPC result.

3. The method of claim 1, wherein applying a model-based MPC comprises deviating an outline of a particular line edge of the photomask pattern layout in a predetermined direction in response to the rule-based MPC result.

4. The method of claim 1, wherein applying a model-based MPC comprises deviating an outline of a particular line end of the photomask pattern layout in a predetermined direction in response to the rule-based MPC result.

5. The method of claim 1, wherein applying a model-based MPC comprises deviating an outline of a particular line corner of the photomask pattern layout in a predetermined direction in response to the rule-based MPC result.

6. The method of claim 1, wherein applying a model-based MPC comprises deviating an outline of the photomask pattern layout by a predetermined amount in response to the rule-based MPC result.

7. The method of claim 1, further comprising preparing a photomask according to the MPC correction.

8. The method of claim 7, further comprising fabricating a device using the prepared photomask.

9. A system comprising:
means for dissecting a photomask pattern layout into a plurality of segments, each segment having at least one evaluation point;
means for applying a rule-based MPC to the photomask pattern layout and generating a rule-based MPC result; and
means for applying a model-based MPC to the plurality of segments of the photomask pattern layout and generating an MPC correction that is influenced by the rule-based MPC result.

10. The system of claim 9, wherein means for applying a model-based MPC comprises means for deviating an outline of the photomask pattern layout in a predetermined direction in response to the rule-based MPC result.

11. The system of claim 9, wherein means for applying a model-based MPC comprises means for deviating an outline of a particular line edge of the photomask pattern layout in a predetermined direction in response to the rule-based MPC result.

12. The system of claim 9, wherein means for applying a model-based MPC comprises means for deviating an outline of a particular line end of the photomask pattern layout in a predetermined direction in response to the rule-based MPC result.

13. The system of claim 9, wherein means for applying a model-based OPC comprises means for deviating an outline of a particular line corner of the photomask pattern layout in a predetermined direction in response to the rule-based MPC result.

14. The system of claim 9, wherein applying a model-based MPC comprises means for deviating an outline of the photomask pattern layout by a predetermined amount in response to the rule-based MPC result.

15. A semiconductor device manufactured at least in part by performing a method comprising:
dissecting a photomask pattern layout into a plurality of segments, each segment having at least one evaluation point;
applying a rule-based MPC to the photomask pattern layout and generating a rule-based MPC result; and
applying a model-based MPC to the plurality of segments of the photomask pattern layout and generating an MPC correction that is influenced by the rule-based MPC result.

16. The method of claim 15, wherein applying a model-based MPC comprises deviating an outline of the photomask pattern layout in a predetermined direction in response to the rule-based MPC result.

17. The method of claim 15, wherein applying a model-based MPC comprises deviating an outline of the photomask pattern layout by a predetermined amount in response to the rule-based MPC result.

18. The method of claim 15, further comprising preparing a photomask according to the MPC correction.
